(19) United States
(12) Patent Application Publication
(10) Pub. No.: US 2011/0288360 A1
(43) Pub. Date: Nov. 24, 2011

(54) COMPOSITIONS FOR NEUTRALIZATION AND DECONTAMINATION OF TOXIC CHEMICAL AND BIOLOGICAL AGENTS

(75) Inventors: Paul M. Puckett, Lake Jackson, TX (US); Mark Livesay, El Cajon, CA (US); Katherine S. Clement, Lake Jackson, TX (US)

(73) Assignee: SUNREZ CORPORATION, El Cajon, CA (US)

(21) Appl. No.: 12/673,040

(22) PCT Filed: Aug. 13, 2008
(86) PCT No.: PCT/US08/73056

§ 371 Date: Feb. 11, 2010

Related U.S. Application Data
(60) Provisional application No. 60/955,432, filed on Aug. 13, 2007.

(51) Int. Cl. A62D 3/35; A01N 37/36; C11D 3/60; A01N 37/42; A01P 1/00; A01N 37/44; A01N 43/16

(52) U.S. Cl. 588/299; 514/561; 514/564; 514/162; 514/453; 514/549; 514/27; 510/110; 588/317

(57) ABSTRACT

Described herein are compositions for neutralization and decontamination of toxic chemical and biological agents. In one embodiment, the subject matter discloses a nontoxic, non-corrosive composition capable of neutralizing and decontaminating toxic chemical and biological agents in a very short period of time. The present subject matter finds utility in a great number of occasions, including, but not limited to, military actions or terrorist attacks where chemical or biological agents are utilized.

### FIELD OF THE SUBJECT MATTER

The present subject matter relates to compositions for neutralization and decontamination of toxic chemical and biological agents. More specifically, the subject matter discloses a nontoxic, non-corrosive composition capable of neutralizing and decontaminating toxic chemical and biological agents in a very short period of time.

### BACKGROUND OF THE SUBJECT MATTER

A biological warfare agent (“BWA”) is an infectious disease or toxin produced by an organism that can be used in bioterrorism or biological warfare. Biological agents include prions, viruses, microorganisms (bacteria and fungi) and some unicellular and multicellular eukaryotes (for example parasites) and their associated toxins (e.g., botulinum toxin, ricin and saxitoxin). BWA have the ability to adversely affect human health in a variety of ways, ranging from allergic reactions that are usually relatively mild, to serious medical conditions, and even death.

Primary chemical warfare agents (“CWA”) include sulfur and nitrogen, mustard agents (mustard gas) and nerve agents such as Sarin and VX. These agents are typically released as a vapor or liquid, and during a chemical attack, the greatest danger would come from either breathing these vapors or absorbing the agent through contact with the skin.

The continued and real threat of the use of CWA and/or BWA during a military action or terrorist attack has become a serious credible threat to U.S. military and civilian personnel. Continued advances in biotechnology and the relative ease of obtaining and preparing large quantities of CWA and/or BWA has significantly increased the chemical and biological warfare threat.

There are a variety of CWA, and their similarities allow them to be classified in groups. These similarities also provide a framework for describing the methods that might be used to neutralize and detoxify these systems. The chemical agents—sarin, soman, and tabun (“G-agents”) and VE, VG, VM, VX (“V-agents”), are all examples of phosphorus-containing compounds, which when reacted chemically, can lose their toxicity. Mustard is an example of an H-agent that can also be reacted chemically and rendered harmless. These materials are all relatively small and reactive chemical compounds. The reactivity of these chemical agents with biological systems (people and animals) and their ability to interfere with the normal function of these biological systems give these CWA their unique potency.

CWA or BWA attacks can be dispersed either in a small local area or over a wide area. Because of the many methods available for dispersion of CWA and BWA, respondents might encounter the agents in a variety of physical states including powder, liquid, aerosol, vapors or combinations thereof. An effective, rapid, and safe (non-toxic to humans/animals, non-corrosive to structural materials, and ecologically sound) decontamination technology is required for the restoration of equipment and facilities following an attack. Decontamination (“decon”) and neutralization are defined herein as the mitigation, de-toxification, or destruction of chemical and biological systems to the extent that these systems no longer cause acute adverse effects to humans or animals.

### Chemical Warfare Agents

Decontamination of chemical agents has focused primarily on chemical warfare agents, particularly on the nerve agents (such as G agents and V agents) and on the blistering agents (such as mustard gas). Decontamination of biological agents is primarily focused on bacterial spores (e.g., anthrax) which are the most difficult of all microorganisms to kill. Several CWA which are likely to pose a threat to both military and civilian populations, are the nerve agents which are phosphorus-containing; these compounds can all be chemically reacted by nucleophilic attack (hydrolysis) or oxidation processes. Included in this collection of phosphorous containing nerve agents are sarin (O-isopropyl methylphosphonofluoridate), soman (O-pinacolyl methylphosphonofluoridate), tabun (O-ethyl-N,N-dimethyl phosphoramidocyanidate) and VX (O-ethyl S-2-diisopropylaminoethyl methyl phosphonothiolate). The chemical structures of these compounds are shown in FIG. 1. With each of these agents, if the phosphorous-containing compound is reacted chemically via hydrolysis or nucleophilic attack by one of the reactive agents, it can be neutralized as a CWA. These nerve agents are sparingly soluble in water with VX being the least soluble. The chemical structure of a VX and VM are shown in FIG. 2. Although mustard is chemically quite distinct from the other CWA's, it can react via hydrolysis at the terminal chlorine atoms, thereby neutralizing the molecule as a CWA. Like the phosphorous containing nerve agents, mustard is only sparingly soluble in water. The chemical structure of mustard (bis(2-chloroethyl)sulfide) is shown in FIG. 3.

Natural decomposition of the CWA's occurs slowly with exposure to water, sunlight, and air (oxygen). Military doctrines state that about 14 days after a CWA attack, exposure to the environment has degraded the threat to the point that it is safe to enter the affected region. Reactions involved in detoxification of chemical agents are generally divided into two broad classes: hydrolytic (water and similar nucleophiles) or oxidation (oxygen) reactions.

### Hydrolytic (Nucleophilic Substitution) Reactions

Hydrolysis/detoxification of chemical agents can be carried out with water, hydroxyl ions or radicals, or other nucleophiles (e.g. amines, sulfides, alcohols, etc.). The use of nucleophiles other than water or hydroxyl ions/radicals is technically not a hydrolysis reaction, but these alternative nucleophiles react via an identical mechanistic pathway producing similar sorts of reaction products. The rate of hydrolysis of mustard and the nature of the products formed depends primarily on the solubility of the agent in water and on the pH of the solution. In the detoxification of mustard, for example, the molecule first forms a cyclic sulfonium cation, which reacts with a nucleophilic reagent (Yang, Y. C., “Chemical Reactions for Neutralising Chemical Warfare Agents,” Chem. Ind., 1995, 9, 334-337). The dominant product is thiodiglycol but this product may react with cyclic sulfonium cations to give secondary intermediates.

The hydrolysis of sarin (“GB”) and soman (“GD”) occurs rapidly under alkaline conditions and gives the corresponding O-alkyl methylphosphonic acid. In contrast, the hydrolysis of VX with hydroxide (OH⁻) ions is more complex. In addition to displacement of the thioalkyl group (i.e., P—S bond breakage), the O-ethyl group can be displaced (i.e., P—O bond breakage) producing a toxic product known as EA-2192 (Yang, Y. C., Berg, F. J., Szafraniec, L. L., Beaudry, W. T., Bunton, C. A., and Kumar. A., “Peroxyhydrolysis of Nerve Agent VX and Model Compounds and Related Nucleophilic Reactions,” J. Chem. Soc., Perkin Trans., 1997, 2, 607-613). Nucleophiles enter and depart the intermediate from an apical position. Electronegative groups, such as —OR (alkoxy) groups, preferentially occupy apical positions and groups that are bulky or electron donors, such as —SR groups, occupy equatorial positions on thiophosphonates. The final product will depend on the balance between the nucleophiles' ability to react at the apical position and the type of leaving group present. The result is that P—S bond cleavage is favored over P—O bond cleavage by a factor of about 5. Peroxyhydrolysis, on the other hand, using hydroperoxide ions in alkaline medium has been shown to involve quantitative P—S cleavage at rates 30-40 times that of neutralization with hydroxide. This selectivity has been related to the relative basicities of the anionic nucleophile and the leaving group abilities of the anions. The oxidation of the —S-(thio-) linkage to a bulkier sulfoxide with increased leaving group ability is also consistent with observed trends.

A catalytic species for acceleration of substitution reactions that has been reported is o-iodosobenzoate (“IBA”). An example illustrating the catalytic reactions of this compound is given by Moss and Zhang (Moss, R. A., and Zhang, H., “Toward a Broad Spectrum Decontaminant for Reactive Toxic Phosphates/Phosphonates: N-Alkyl-3-Iodosopyridinium-4-Carboxylates,” Tetrahedron Letters, 1993, 34, 6225-6228). In this example, IBA is converted to iodoxybenzoate (“IBX”) via oxidation which then participates in the reaction with the CW agent. The IBA compound was also functionalized to introduce surface activity (surfactant character) to the active group (Moss, R. A., Kim, K. Y., and Swarup, S., “Efficient Catalytic Cleavage of Reactive Phosphates by an o-Iodosobenzoate Functionalized Surfactant,” J. Amer. Chem. Soc., 1986, 108, 788-793). Metal ion-amine complexes, with surface active moiety, were also developed and shown to exhibit catalytic effects in substitution reactions. Enzymes (such as organophosphorous acid anhydrolase) have also been shown to accelerate substitution reactions with the G and VX agents.

While hydrolysis and catalyzed hydrolytic type reactions are very useful in neutralizing CW agents over a range of pH (both acidic, neutral, and basic), this type of reaction mechanism is completely ineffective in neutralizing BW agents, unless the reaction is carried out under very basic conditions (pH=10-14).

### Oxidation Reaction

Oxidative decontamination reactions and methods are particularly useful for mustard and VX (Yang, Y. C., “Chemical Reactions for Neutralising Chemical Warfare Agents,” Chem. Ind., 1995, 9, 334-337). One oxidant used in early studies was potassium permanganate. Recently, a mixture of potassium compounds —KHSO₅, KHSO₄, and K₂SO₄— was developed to use in the decontamination process. Several peroxygen compounds have also been shown to oxidize chemical agents (e.g., perborate, peracetic acid, m-chloroperoxybenzoic acid, magnesium monoperoxyphthalate, and benzoyl peroxide). More recently, anions of hydroperoxycarbonate were produced by the reaction of bicarbonate ions with hydrogen peroxide and have been shown to effectively oxidize CWA like mustard and VX. Polyoxymetalates are being developed as room temperature catalysts for oxidation of chemical agents but the reaction rates are reported to be slow at this stage of development. Some of these compounds undergo a color change upon interaction with chemical agents to indicate the presence of chemical agents.

### Biological Warfare Agents

The BWA threat can be more serious than the CWA threat, which is in part because of the high toxicity of BWA's, their ease of acquisition and production, difficulty in detection, and the ability of many to persist in the environment for exceptionally long periods (years to decades). There are hundreds of biological warfare agents. They may be grouped into the categories of spore forming bacterium (e.g., anthrax), vegetative bacterium (e.g., plague, cholera), virus (e.g., smallpox, yellow fever), and bacterial toxins (e.g., botulinum, ricin). Bacterial spores are recognized to be the most difficult microorganisms to kill.

Bacterial spores are highly resistant structures formed by certain gram-positive bacteria usually in response to stresses in their environment. The most important spore-formers are members of the genera, Bacillus and Clostridium. Spores are considerably more complex than vegetative cells. The outer surface of a spore consists of the spore coat that is typically made up of a dense layer of insoluble proteins usually containing a large number of disulfide bonds. The cortex consists of peptidoglycan, a polymer primarily made up of highly crosslinked N-acetylglucosamine and N-acetylmuramic acid. The spore core contains normal (vegetative) cell structures such as ribosomes and a nucleoid.

Since their discovery, considerable research has been carried out to investigate methods to kill bacterial spores. Although spores are highly resistant to many common treatments, a few antibacterial agents are also sporicidal. However, many powerful bactericides may only inhibit spore germination or outgrowth (i.e., sporistatic) rather than being sporicidal. Examples of known sporicidal reagents, using relatively high concentrations, include glutaraldehyde, formaldehyde, iodine and chlorine oxyacids (bleaches), peroxy acids, methyl bromide, and ethylene oxide. However, all of these compounds are not only sporicidal but toxic to humans/animals and some are also highly corrosive.

There are several mechanisms generally recognized to kill spores. These mechanisms can operate singularly or simultaneously. In one mechanism, the dissolution or chemical disruption of the outer spore coat can allow penetration of oxidants into the interior of the spore. Several studies (King, W. L., and Gould, G. W., “Lysis of Bacterial Spores with Hydrogen Peroxide,” J. Appl. Bacteriol., 1969, 32, 481-490) and (Gould, G. W., Stubbs, J. M., and King, W. L., “Structure and Composition of Resistant Layers in Bacterial Spore Coats,” J. Gen. Microbiol., 1969) suggest that the S—S (disulfide) rich spore coat protein forms a structure which successfully masks oxidant-reactive sites. Reagents that disrupt hydrogen and S—S bonds increase the sensitivity of spores to oxidants. Peptidoglycan, which is loosely cross-linked and electronegative, makes up the cortex of a spore. In another mechanism, cationic interaction between a disinfectant solution and peptidoglycan can cause collapse of the cortex and loss of resistance.

The peptidoglycan of spore-forming bacteria contains teichoic acids (i.e., polymers of glycerol or ribitol joined by phosphate groups). In another mechanism, disruption of the teichoic acid polymers can cause deficiencies in the peptidoglycan structure making the spore susceptible to attack. Additionally, certain surfactants can increase the wetting potential of the spore coat to such an extent as to allow greater penetration of oxidants into the interior of the spore.

### Conventional Decontamination Solutions and Processes

There are a variety of materials that can be used to address the decontamination of one or more CW or BW agents. Historically, decontamination solutions have focused strictly on the killing and neutralization of chemical and biological agents. Little emphasis has been placed on restoration and re-use of facilities and equipment. Instead, these items were considered to be expendable and were expected to be replaced in the event of a CWA and/or BWA attack. Thus, most decontamination formulations currently in use are both highly toxic to humans and highly corrosive to humans, facilities, equipment and the environment. Many of the materials used in the past for decontamination address either CWA or BWA but not both, and often only a subclass of either CW or BW agents.

The neutralization of chemical warfare agents began by using bleaching powder to neutralize mustard agents. Supertropical bleach, a mixture of 93% calcium hypochlorite and 7% sodium hydroxide, was then formulated and is more stable than bleach in long-term storage and easier to spread. Mustard gas reacts with bleach by oxidation of the sulfide to sulfoxide and sulfone and by dehydrochlorination to form compounds such as (CH₂CH)₂SO₂. The G agents are converted by hydrolysis to the corresponding phosphonic acids with the hypochlorite anion acting as a catalyst. At typically high pH (>10), the solubility of VX is significantly reduced and its deprotonated nitrogen is oxidized leading to consumption of greater than stoichiometric amounts of bleach.

A non-aqueous liquid composed of 70% diethylenetriamine, 28% ethylene glycol monomethyl ether, and 2% sodium hydroxide, referred to as Decontamination Solution Number 2 (“DS2”), is a highly effective decontaminant for CW agents. Ethylene glycol monomethyl ether, because of toxicity concerns, was replaced with propylene glycol monomethyl ether to produce a new formulation referred to as DS2P. DS2 (and DS2P) is a very aggressive solution and attacks paints, plastics, and leather materials. To minimize these problems, the contact time with DS2 is generally limited to 30 minutes followed by rinsing with large amounts of water. Personnel handling DS2 are required to wear respirators with eye shields and chemically protective gloves, because the solution is very dangerous to handle. The reactions of DS2 and DS2P with mustard lead to elimination of HCl. The nerve agents react with DS2 and DS2P to form diesters, which further decompose to the corresponding phosphonic acid. DS2 is not very effective in killing bacterial spores. Only 1-log kill (90%) was observed for Bacillus subtilis after 1 hour of treatment (Tucker, M. D., Williams, C. V., Tadros, M. E., Baca, P. M., Betty, R. and Paul, J., “Aqueous Foam for the Decontamination and Mitigation of Chemical and Biological Warfare Agents,” Sandia Technical Report SAND2000-1419, 2000, Sandia National Laboratories, Albuquerque, N. Mex.).

A mixture consisting of 76% water, 15% tetrachloroethylene, 8% calcium hypochlorite, and 1% anionic surfactant mix was shown to enhance the solubility of agents but contains toxic and corrosive material (Ford, M. S., and Newton, W. E., “International Materiel Evaluation of the German C8 Emulsion,” DPG-FR-88-009, 1989 Final Report, U.S. Army Dugway Proving Ground: Dugway, Utah).

There are a variety of formulations that are currently used for the decontamination of personnel in the event of a CW agent attack, primarily used by the U.S. military and are, in general, not utilized in the civilian community. One formulation is a M258 skin decontamination kit that mimics a Soviet kit recovered in Egyptian tanks in the Yom Kippur War. The kit consists of two packets: Packet I contains a towelette pre-wetted with phenol, ethanol, sodium hydroxide, ammonia, and water. Packet II contains a towelette impregnated with chloramine-B and a sealed glass ampoule filled with zinc chloride solution. The ampoule in packet II is broken and the towelette is wetted with the solution immediately prior to use. The presence of zinc chloride maintains the pH of the chloramine-B in water between 5 and 6 which would otherwise rise to 9.5.

Another formulation is the M291 kit, which is a solid sorbent system (Yang, Y. C., “Chemical Reactions for Neutralising Chemical Warfare Agents,” Chem. Ind., 1995, 9, 334-337). The kit is used to wipe bulk liquid agent from the skin and is composed of non-woven fiber pads filled with a resin mixture. The resin is made of a sorptive material based on styrene/divinylbenzene and a high surface area carbonized macroreticular styrene/divinylbenzene resin, cation-exchange sites (sulfonic acid groups), and anion-exchange sites (tetraalkylammonium hydroxide groups). The sorptive resin can absorb liquid agents and the reactive resins are intended to promote hydrolysis of the reactions. However, a recent NMR study has shown neither VX nor mustard simulants were hydrolyzed on the XE-555 resin surface during the first 10 days (Leslie, D. R., Beaudry, W. T., and Szafraniec, L. L., “Sorption and Reaction of Chemical Agents by a Mixed Sorptive/Reactive Resin,” CRDEC-TR-292, 1991, CRDEC: Aberdeen Proving Ground, MD). GD slowly hydrolyzed with a half-life of about 30 hours. The observed rapid agent decontamination in the field is achieved physically by wiping. This resin blend was found to be less corrosive to the skin than the M258 system.

Most formulations used for the decontamination of BW agents by both military and civilian agencies contain the hypochlorite anion (i.e., bleach or chlorine-based solutions). Solutions containing concentrations of 5% or more bleach have been shown to kill spores (Sagripanti, J. L., and Bonifacino, A., “Comparative Sporicidal Effects of Liquid Chemical Agents,” Appl. Environ. Microbiol., 1996, 62, 545-551). A variety of hypochlorite solutions have been developed for decontamination of BW agents including 2-6 percent aqueous sodium hypochlorite solution (household bleach), a 7 percent aqueous slurry or solid calcium hypochlorite (HTH), 7 to 70 percent aqueous slurries of calcium hypochlorite and calcium oxide (supertropical bleach, STB), a solid mixture of calcium hypochlorite and magnesium oxide, a 0.5 percent aqueous calcium hypochlorite buffered with sodium dihydrogen phosphate and detergent, and a 0.5 percent aqueous buffered calcium hypochlorite solution. Although all of these solutions, with varying efficiency, are capable of killing spores, each is also highly corrosive to equipment, dangerous to personnel, and hazardous to the environment.

The compounds that have been developed for use in detoxification of both CW and BW agents have been deployed in a variety of ways, including liquids, foams, fogs and aerosols. Stable aqueous foams have been used in various applications including fire fighting and law enforcement applications (such as prison riot containment). Such foams, however, have typically been made using anionic surfactants and anionic or nonionic polymers. These foams, unfortunately, have not been effective in the chemical decomposition and neutralization of most chemical and biological weapons agents. They did not have the necessary chemical capabilities to decompose or alter CW agents, and they are not effective in killing or neutralizing the bacteria, viruses and spores associated with some of the more prevalent BW agents.

Gas phase reagents are attractive for decontamination if an environmentally acceptable gas can be identified. The advantage of gas decontaminants is their penetrating (diffusing) capability that makes them a necessary complement to the other decontamination techniques. The disadvantages of gas decontaminants is their high toxicity to humans, typically corrosive nature to a variety of surfaces, and their limitation that they generally can only be applied in enclosed spaces. Ozone, chlorine dioxide, methyl bromide, ethylene oxide, and paraformaldehyde have all been investigated for decontamination applications. These are all known to be effective against biological agents. The effectiveness of ozone for killing spores is well established (Raber, E., McGuire, R., Shepley, D., Hoffman, M., Alcarez, A., Earl, W., and Currier, R., “Oxidizers: The Solution for Chemical Agent Decontamination,” DOE Chemical and Biological Nonproliferation Program, 1998 Summer Meeting, Washington D.C.). While ozone is an attractive decontaminant, experiments by Edgewood Chemical Biological Center (“ECBC”) show that it is not effective towards GD and with VX it leads to the formation of toxic products via P—O bond cleavage.

Accordingly, there is a need for nonhazardous compositions that are effective in decomposing chemical and biological warfare agents. There is a further need for compositions that are non-toxic to humans, animals and the environment, non-corrosive to most materials and can be produced and delivered as a pH (=7+/−1) neutral solution. Additionally, there is a need for a composition that may be deployed in large quantities that rapidly and effective neutralize both chemical and biological warfare agents.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 depicts the skeletal formula for several chemical agents, namely the G-Agents, Sarin (C₄H₁₀FO₂P), Soman (C₇H₁₆FO₂P), Cyclosarin (C₇H₁₄FO₂P), Tabun (C₅H₁₁N₂O₂P), and GV (C₆H₁₆FN₂O₂P).

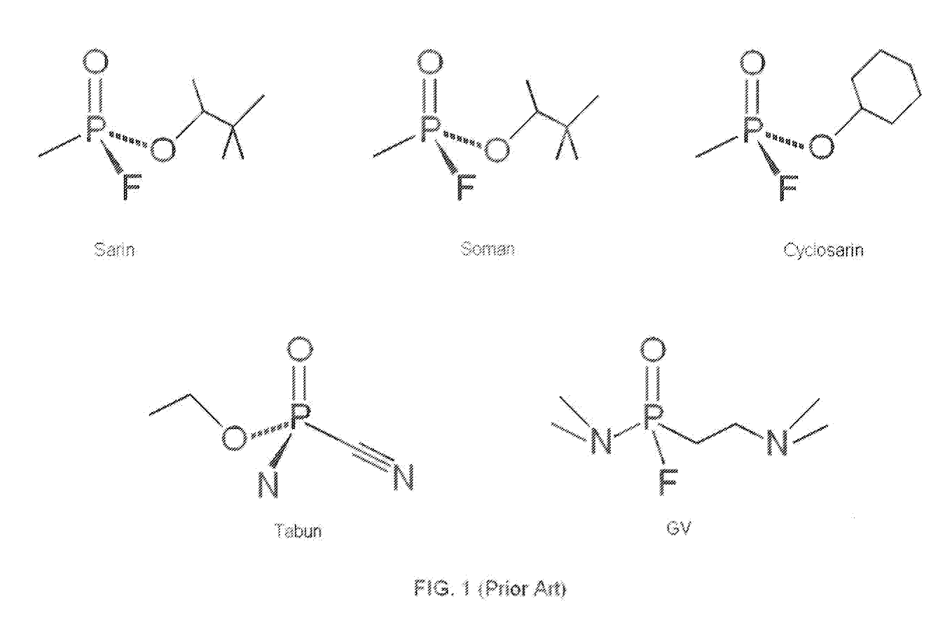

FIG. 2 depicts the skeletal formula for several chemical agents, namely the V-Agent, VX (C₁₁H₂₆NO₂PS), and VM (C₉H₂₂NO₂PS).

FIG. 3 depicts the skeletal formula for a chemical agent, namely the H-Agent, Mustard (C₄H₈Cl₂S).

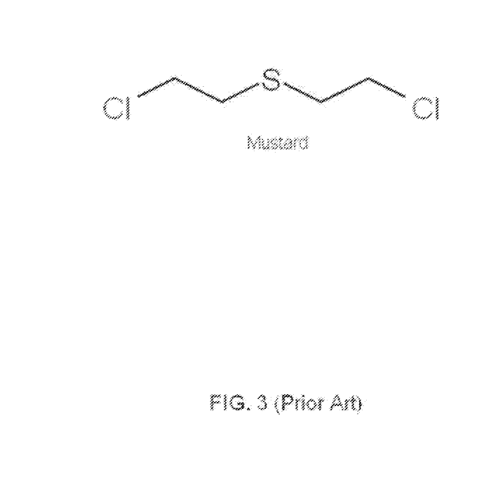

FIG. 4 is a table showing the efficiency of neutralization and decontamination of CWA and BWA for examples 1 through 5.

FIG. 5 is a table showing the efficiency of neutralization and decontamination of CWA and BWA for examples 6 through 11.

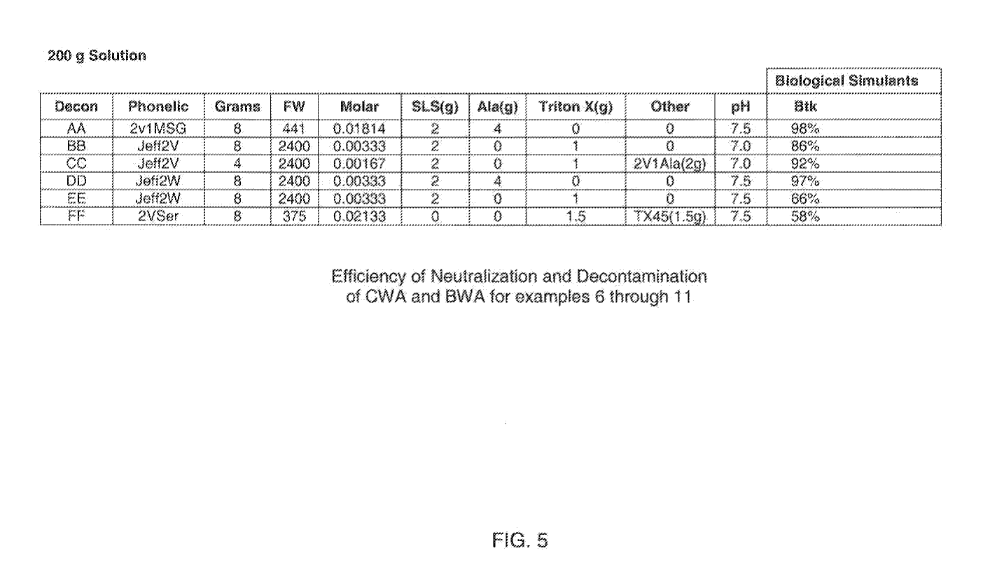

### DETAILED DESCRIPTION OF THE SUBJECT MATTER

All publications herein are incorporated by reference to the same extent as if each individual publication or patent application was specifically and individually indicated to be incorporated by reference. The following description includes information that may be useful in understanding the present subject matter. It is not an admission that any of the information provided herein is prior art or relevant to the presently claimed subject matter, or that any publication specifically or implicitly referenced is prior art. Unless defined otherwise, technical and scientific terms used herein have the same meaning as commonly understood by one of ordinary skill in the art to which this subject matter belongs. Singleton et al., Dictionary of Microbiology and Molecular Biology 3^{rd} ed., J. Wiley & Sons (New York, N.Y. 2001); March, Advanced Organic Chemistry Reactions, Mechanisms and Structure 5^{th} ed., J. Wiley & Sons (New York, N.Y. 2001); and Sambrook and Russell, Molecular Cloning: A Laboratory Manual 3rd ed., Cold Spring Harbor Laboratory Press (Cold Spring Harbor, N.Y. 2001), provide one skilled in the art with a general guide to many of the terms used in the present application.

One skilled in the art will recognize many methods and materials similar or equivalent to those described herein, which could be used in the practice of the present subject matter. Indeed, the present subject matter is in no way limited to the methods and materials described. For purposes of the present subject matter, the following terms are defined below.

Ionic Surfactant—large organic molecules carrying at least one charge.

Anionic Surfactant—based on sulfate, sulfonate or carboxylate anions, such as sodium dodecyl sulfate (“SDS”), ammonium lauryl sulfate, and other alkyl sulfate salts, sodium laureth sulfate, also known as sodium lauryl ether sulfate (“SLES”), and alkyl benzene sulfonate. Anionic surfactants derived from natural sources include soaps (salts of fatty acids) and phosphatidic acid.

Cationic Surfactant—based on quaternary ammonium cations, including cetyl trimethylammonium bromide (“CTAB”) a.k.a. hexadecyl trimethyl ammonium bromide, and other alkyltrimethylammonium salts, cetylpyridinium chloride (“CPC”), polyethoxylated tallow amine (“POEA”), benzalkonium chloride (“BAC”), and benzethonium chloride (“BZT”).

Decon—abbreviation for decontamination.

Nonionic Surfactant—organic molecules with no charge including:
Oxide polymers including alkyl and aryl poly(ethylene oxide) many of these are marketed as TRITON surfactants, copolymers of poly(ethylene oxide) and poly(propylene oxide) that are marketed commercially as poloxamers or poloxamines;
Alkyl polyglucosides, such as octyl glucoside and decyl maltoside;
Fatty alcohols including cetyl alcohol and oleyl alcohol; and
Fatty acid amides including cocamide MEA, cocamide DEA, and cocamide TEA.

Surfactant—a surface active agent that is used to alter surface tension of one or more liquids.

Zwitterionic Surfactant—amphoteric—containing both a positive and negative charge on the same backbone, including dodecyl betaine, dodecyl dimethylamine oxide, cocamidopropyl betaine, and cocoamphoglycinate. Biologically derived zwitterionic surfactants are available including phosphatidyl choline (major component of lecithin), and cephalin (phosphatidylethanolamine).

The present invention provides compositions effective in neutralizing and decontaminating chemical and biological warfare agents. The disclosed compositions are non-toxic to humans, animals and the environment, non-corrosive to most materials and can be produced and delivered as a pH (=7+/−1) neutral solution. Additionally, the disclosed compositions are capable of rapid and thorough neutralization and decontamination of both chemical and biological warfare agents, and may be deployed in large quantities.

The compositions of the present invention are useful in a variety of applications where toxic chemical or biological contamination may be of concern. These compositions are particularly suitable for use against biological warfare agents, chemical warfare agents and combined chemical and biological warfare agents.

For the first responder, it is important to decontaminate facilities and/or equipment to an acceptable level in a very short time so that casualties can be located and treated. In the restoration scenario, time is of less importance but collateral damage, public perception, and re-certification (i.e., complete decontamination) is of greater consequence. A common formulation effective against all chemical and biological agents is required that must be suitable for use on a wide variety of building materials commonly found in civilian facilities. Additionally, any neutralization formulation must be able to be rapidly deployed in large quantities by first responders to effectively neutralize CWA and BWA while remaining relatively harmless to people, animals and property. In addition, the formulation should render CWA and BWA harmless in a reasonable period of time so that relatively rapid restoration of facilities may be achieved.

As mentioned, another goal of a good decontamination agent should be to mimic the natural processes of breakdown, such as those that occur with hydrolysis and oxidation, but do so at a dramatically faster rate, producing end products from the reaction that are not harmful to the environment or to humans and animals. Ideally, this decon technology should be applicable to a variety of structures such as the decontamination of both facilities and equipment, without degrading and corroding the facilities and equipment being treated.

The subject matter solutions for neutralization and decontamination of toxic chemical and biological agents, and especially chemical and biological warfare agents and the methods of preparing these formulations, overcome many of the deficiencies of existing compounds and processes. Specifically, materials containing surface active agents and reactive compounds that can be delivered as pH (=7+/−1) neutral aqueous solutions are described herein, which enhance the rate of reactions leading to neutralization of chemical agents and termination of biological agents.

Formulations and methods of making the same that neutralize the adverse health effects of both toxic chemical and biological agents, including many toxic industrial chemicals, are described herein. Contemplated aqueous formulations are non-toxic to humans/animals, non-corrosive to most structural materials (steel, aluminum, concrete, wood, polymeric paints and coatings, etc.), and can be produced and delivered as a pH (=7+/−1) neutral solution. The formulations provide surface active agents that serve to effectively render the chemical and biological compounds, particularly CWA and BWA compounds, susceptible to attack and at least one reactive compound that serves to react with and neutralize (detoxify CWA or kill BWA) the agents. The reactive compound(s) are natural products, or reaction products made from naturally occurring chemicals, that are generally regarded as safe (“GRAS”).

In a contemplated embodiment, the formulations for decontamination and neutralization of at least one chemical warfare agent, biological warfare agent or combination thereof include: a) a neutral (pH=7+/−1) aqueous solvent, b) at least one surface active agent, c) at least one reactive agent that accelerates hydrolysis and/or participates in nucleophilic reactions in water, and/or d) at least one reactive agent that contains a free phenolic moiety as a portion of the molecule. Unlike many previous decontaminating formulations, contemplated formulations do not incorporate any type of oxidizing agent, nor do they require a strongly basic (pH >10) or strongly acidic (pH <4) formulation to neutralize either the CW or BW agents. The advantages of using a neutral (pH=6-8) water based (aqueous) solvent are well known, including low cost, availability, no volatile organic compounds (“VOC”), non-flammable, non-hazardous to the environment and personnel (no HAZMAT precautions required), and ease of transport (no regulatory requirements). In the present subject matter the percentage composition of the aqueous solution may be up to ninety-nine percent (99%).

As mentioned, the at least one surface active agent may be added to the formulation. Surface active agents, or “surfactants” are organic compounds that are amphiphilic, which means that they contain both hydrophobic groups (their “tails”) and hydrophilic groups (their “heads”). They are soluble in both organic solvents and water. Surfactants find utility as wetting agents that lower the surface tension of a liquid, allowing easier spreading of a liquid across a surface, or lower the interfacial tension between two liquids. In the present subject matter the percentage composition of the surface active agent, or surfactant, in the aqueous solution is no more than ten percent (10%). Surfactants are categorized into two primary groups—ionic (which includes anionic, cationic, zwitterionic) and non-ionic. Surfactants are found in a huge number of products that are encountered daily, including: detergents, shampoos, hair conditioners, fabric softeners, emulsifiers, paints, adhesives, inks, soil remediation, formulations, wetting agents, ski and snowboard waxes, foaming and defoaming agents, laxatives, agrochemical formulations—as both herbicides and insecticides, and may be used as biocides (sanitizers).

Commonly encountered surfactants that are typical of each category include:

Ionic—organic molecules carrying at least one charge;

Anionic—(based on sulfate, sulfonate or carboxylate anions) such as SDS, ammonium lauryl sulfate, and other alkyl sulfate salts, sodium laureth sulfate, also known as SLES, and alkyl benzene sulfonate. Anionic surfactants derived from natural sources include soaps (salts of fatty acids) and phosphatidic acid;

Cationic—(based on quaternary ammonium cations) including CTAB a.k.a. hexadecyl trimethyl ammonium bromide, and other alkyltrimethylammonium salts, CPC, POEA, BAC, and BZT;

Zwitterionic—(amphoteric—containing both a positive and negative charge on the same backbone) including dodecyl betaine, dodecyl dimethylamine oxide, cocamidopropyl betaine, and cocoamphoglycinate. Biologically derived zwitterionic surfactants are available including phosphatidyl choline (major component of lecithin), and cephalin (phosphatidylethanolamine); and

Nonionic—organic molecules with no charge (positive or negative); Oxide polymers including alkyl and aryl poly(ethylene oxide) many of these are marketed as TRITON surfactants, copolymers of poly(ethylene oxide) and poly(propylene oxide) that are marketed commercially as poloxamers or poloxamines; Alkyl polyglucosides, such as octyl glucoside and decyl maltoside; Fatty alcohols including cetyl alcohol and oleyl alcohol; and Fatty acid amides including cocamide MEA, cocamide DEA, and cocamide TEA.

The at least one reactive agent is added to a contemplated embodiment of the composition. As discussed previously, the neutralization of CWA's is typically accomplished in the environment via hydrolysis (nucleophilic reaction) or oxidation reactions. The contemplated reactive agent is selected from those agents that are proficient in hydrolysis and/or participate in nucleophilic reactions in water. In the present subject matter the percentage composition of the reactive agent in the aqueous solution is no more than ten percent (10%). Contemplated reactive agents for these nucleophilic reactions may include, but are in no way limited to, sulfur (e.g. sulfides and sulfhydryl), nitrogen (e.g. alkyl amines, dialkylamines, ammonia), and oxygen (e.g. water, hydroxide, alcohol, alkoxide). However, at neutral pH (=6-8) the anionic form (sulfide, hydroxide, alkoxide) is usually not present. These nucleophilic groups are present in relatively high concentrations in the biochemicals found in the environment, which explains at least partially how the CW agents degrade naturally.

In order to dramatically increase the rate of degradation that occurs naturally, water soluble reactive agents may be added to both increase the reaction rate of water itself entering the reaction with the CWA, and adding additional nucleophiles that can also enter into reaction with the CWA thus neutralizing it. Standard chemical logic suggests that addition of either acidic or basic catalysts can often lead to increased rates of hydrolysis, however, addition of strong acids or bases moves the pH of aqueous solutions away from the ideal pH=7 of neutrality. Standard chemical logic also suggests that polar reactants will increase the rate of reaction of hydrolysis; this is often accomplished by the addition of salts to the solution (ZnCl₂, KBr, NaI, quaternary ammonium halides, etc.). However, these ionic salts tend to make aqueous solutions very corrosive to metallic structures.

Contemplated reactive agents that accelerate hydrolysis and/or participate in nucleophilic reactions in aqueous environments were chosen from small available biochemicals. It has been discovered that the addition of amino acids, which typically exist as polar but nearly neutral zwitterionic species, in water increases the rate of neutralization of CWA. With the variety in the amino acids that occur naturally, it is possible to adjust acidity and basicity of the solution by selection of different combinations of amino acids. The amino acids that will work in the formulation include standard amino acids like alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, and non-standard amino acids like gamma-aminobutyric acid and monosodium glutamate (MSG), ornithine, homocysteine, 4-hydroxyproline, hydroxylysine, sarcosine, taurine (2-aminoethanesulfonic acid) and aspartame. Other highly polar but nearly neutral zwitterionic structures that will increase the rate of neutralization for CWA are choline, trimethylglycine (also commonly known as TMG or glycine betaine), and carnitine (3-hydroxy-4-trimethylammoniumbutanoate). Additionally, other naturally occurring biochemicals that can increase neutralization rates are found among the polar and water soluble vitamins which include but are not limited to thiamine (“B1”), riboflavin (“B2”), niacin (“B3”), pantothenic acid (“B5”), pyridoxine (“B6”), biotin (“B7”), folic acid (“B9”), cyanocobalamin (“B12”), and naturally occurring weak acids and partially or fully buffered salts (sodium, potassium, calcium, magnesium and zinc) of the same including acetic acid, ascorbic acid (“C”), citric acid, lactic acid and tartaric acid.

The fourth component that is added to form the compositions contemplated herein is also a reactive agent, which contains a free phenolic moiety as a portion of the molecule. Phenolic compounds are ubiquitous in nature, perform a multitude of roles, and provide unique characteristics in biological systems. The hydroxyl of the phenolic unit provides polarity and some water solubility, as well as acting as a weak acid (pKa=10) in aqueous environments. In the present subject matter the percentage composition of the free phenolic agent in the aqueous solution is no more than ten percent (10%). Lignin, a polymeric phenolic which provides structural support in plants, is produced from three monolignols: coniferyl alcohol, sinapyl alcohol and paracoumaryl alcohol. Lignin is the third most abundant organic compound on earth after cellulose and chitin. When wood (about 30% dry weight lignin) is burned to cook meat it is the phenolic char derivatives of lignin, guaiacol and syringol, that provide much of the flavor. Eugenol is a phenolic flavoring agent that has been used for many centuries which is extracted from essential oils (clove, nutmeg, and cinnamon). Vanillin is another phenolic flavoring agent that is extracted from a plant source. The hydrolysable tannins which are produced by numerous plants are derivatives of a sugar and a phenolic, gallic acid. Particularly good sources of hydrolysable tannins are grapes (red wine), cranberries, strawberries, blueberries, and pomegranates which are often consumed for their antioxidant and health benefits. Salicylic acid is a phenolic that serves as a plant hormone and was originally isolated from the bark of willow trees. Chewing on willow bark as a fever reducer has been known since ancient times. Currently, salicylates find their primary uses in skin crèmes, aspirin, oil of wintergreen flavoring agents, and bismuth derivatives (Pepto-Bismol). Capsaicin is the phenolic component that provides the hot in chili peppers. Thyroxine (often abbreviated as T4) is the major phenolic hormone secreted by the thyroid gland that controls metabolic processes in the body.

Contemplated reactive agents containing a free phenolic moiety as a portion of the molecule, are used to bring increased biological activity to the decon compositions. While this component provides some additional reactivity to hydrolytic and nucleophilic neutralization related to CWA, it is the neutralizing affect that it has on biological systems particularly BWA that is desired. Contemplated phenolic components that may be utilized are either water soluble phenolics or phenolic derivatives of vanillin, salicylic acid, gallic acid, ellagic acid, ethyl vanillin (3-ethoxy-4-hydroxybenzaldehyde), carvacrol, curcumin, oleocanthal, oleuropein, piceatannol, pterostilbene. resveratrol, salicylaldehyde, tyrosol, hydroxytyrosol, vanillic acid, alkyl vanillate, and related compounds.

A variety of additional phenolics is available from natural sources, that would be suitable for this application and they are generally categorized as polyphenols. Polyphenols are a group of chemical substances found in plants, characterized by the presence of more than one phenol unit or building block per molecule. Polyphenols are generally divided into hydrolyzable tannins (gallic acid esters of sugars) and phenylpropanoids, such as lignins (secoisolariciresinol diglycoside), flavonoids, and condensed tannins. The largest class and best studied polyphenols are the flavonoids, which include several thousand compounds, among them the flavonols (Quercetin, Gingerol, Kaempferol, Myricetin, Resveratrol, Rutin), flavones (Apigenin, Luteolin), catechins (Epicatechins, Catechin Gallates, Theaflavin), flavanones (Hesperiden, Naringenin, Silibenin, Eriodictyol), anthocyanidins (Pelargonidin, Peonidin, Cyanidin, Delphinidin, Malvidin) isoflavonoids (Daidzein, Genistein, Glycitein) and coumestans (Coumestrol).

The viscosity of the contemplated compositions disclosed herein may need to be physically altered to aid in dispersion, application, storage or other considerations. Viscosity modification provides improvements in application and ease of use for the decontaminating compositions, without necessarily altering its effectiveness. The change in the viscosity of the composition can make it easier to spray the solution, or to apply the composition to a vertical surface and have it remain without running down the surface and pooling at the base. There are many conventional and suitable methods and components known to those skilled in the art to alter the viscosity of aqueous solutions, particularly to thicken the formulation, and those methods/components are contemplated herein. Some contemplated examples of water soluble polymers that are often used to modify viscosity of aqueous systems are, polyvinyl alcohol, guar gum, cellulose derivatives like carboxymethylcellulose, methylcellulose, and hydroxyethylcellulose, (cationic or non-ionic) polydiallyl dimethyl ammonium chloride, polyethyleneoxides, polyacrylamides and mixtures thereof.

Additionally, other catalysts and reactive agents and mixtures of catalysts and/or reactive agents can be successfully incorporated into contemplated formulations to enhance rates of reaction. Other compounds may also be added to the formulation as needed to enhance other reactions with the CWA and BWA. It is anticipated that such additions will permit those skilled in the art to adapt the formulations disclosed herein to their requirements without the need for undue experimentation.

Compositions disclosed herein are designed to neutralize or detoxify CW and BW agents, but can also be used in connection with less severe chemical and biological systems. For instance the removal of nuisance microorganisms from a surface is a common and necessary task. Neutralization of chemicals and some of their toxic effects is also an important process. Chemical agents that can be neutralized by contemplated compositions include o-alkyl phosphonofluoridates, such as sarin and soman, o-alkyl phosphoramidocyanidates, such as tabun, o-alkyl, s-2-dialkyl aminoethyl alkylphosphonothiolates and corresponding alkylated or protonated salts, such as VX, mustard compounds, including 2-chloroethylchloromethylsulfide, bis(2-chloroethyl)sulfide, bis(2-chloroethylthio)methane, 1,2-bis(2-chloroethylthio)ethane, 1,3-bis(2-chloroethylthio)-n-propane, 1,4-bis(2-chloroethylthio)-n-butane, 1,5-bis(2-chloroethylthio)-n-pentane, bis(2-chloroethylthiomethyl)ether, and bis(2-chloroethylthioethyl)ether, Lewisites, including 2-chlorovinyldichloroarsine, bis(2-chlorovinyl)chloroarsine, tris(2-chlorovinyl)arsine, bis(2-chloroethyl)ethylamine, and bis(2-chloroethyl)methylamine, saxitoxin, alkyl phosphonyidifluoride, alkyl phosphonites, chlorosarin, chlorosoman, amiton, 1,1,3,3,3-pentafluoro-2-(trifluoromethyl)-1-propene, 3-quinuclidinyl benzilate, methylphosphonyl dichloride, dimethyl methylphosphonate, dialkyl phosphoramidic dihalides, dialkyl phosphoramidates, arsenic trichloride, dialkyl aminoethyl-2-chlorides, phosgene, chlorine, cyanogen chloride, chloropicrin, chloroacetophenone, 2-chlorobenzalmalononitrile, phosphorous oxychloride, phosphorous trichloride, phosphorus pentachloride, alkyl phosphites, sulfur monochloride, sulfur dichloride, and thionyl chloride.

In one contemplated embodiment, oils, greases, waxes, salves, ointments, lotions, gels, or creams may be produced with the compositions disclosed, which may provide protection from the negative effects of nuisance microorganisms on surfaces where a permanent coating is not possible or desirable.

In other contemplated embodiments, these multicomponent formulations may act as wood, plant or cellulose preservatives, such that when ingested by social insects like isoptera (termites), the materials will inhibit their growth or kill them, especially because these insects are dependent on the action of gut bacteria to digest and utilize cellulosic foods.

In yet another embodiment, the formulation compositions may be adjusted to be dispersed or dissolved in water making an aqueous all natural antimicrobial surfactant solution that can be used in a variety of environments, from the home, to medical facilities or commercial operations that require antiseptic environments.

The specific mechanism for the kill or neutralization of BW agents by contemplated formulations is not well understood. In the case of vegetative bacterial cells and viruses, the kill mechanism is likely related to the surface active agent in the composition, or due to the presence of reactive agents containing phenolic moieties in the composition, or the combination of these two. Many surface active agents and phenolic compounds are known to modify the structure of cell membranes. For microbes that have only one cell membrane holding them intact, this can be deadly. Typically a spore must be opened or breached sufficiently for the interior to be exposed to an agent that will neutralize the spore. The spore coat protects the living biochemistry of the cell interior and must be breached to effectively kill the spore. Breaching the cell wall of a spore is incredibly difficult and typically requires strong oxidizing agents, strong acids or bases, or very high heat. The synergistic combination of moisture, the selected water soluble reactive agents, surfactants, and phenolic components allow the spore to be breached and killed under pH neutral conditions.

Some surfactants are known to denature cellular proteins and to act as bactericides and algaecides. This function is becoming quite common in soaps, shampoos and detergents. The cationic surfactants, fatty alcohols, and cationic hydrotropes are typically used for this purpose and by denaturing the proteins in a cell wall provide a means to open a microbe to attack by a reactive agent which interferes with and neutralizes a microbe. Included among the commonly used quaternary ammonium compounds are surfactants such as benzalkonium chloride, cetylpyridinium chloride and cetyltrimethyl ammonium bromide. Depending upon the concentration of the surfactant used in the formulation, up to 99.9999% (log 6 kill) or more of some biological agents can be neutralized (killed) within approximately one hour. This however, will not work at all with spore forming bacteria like anthrax, which are highly resistant to any type of surfactant based biocide.

An advantage of contemplated compositions are that the surface active agents, reactive agents, and additional chemical compounds used to adjust viscosity and pH can be stored separately from the solvent (water) of the formulation prior to use. The separation of the reactive agents and other chemical compounds from the solvent of the formulation is useful in increasing storage stability of these chemicals. Additionally, because water is typically available at most work sites where the neutralization reactions need to be done, the reactive agents associated with the decontaminating can be packaged and shipped separately from the water, and then blended immediately before use. This separation of final components aids in the economy of transport. This separation of formulation components also provides an easy path for production and use of this solution in kit form.

The present subject matter is also directed to a kit for neutralization and decontamination of toxic chemical and biological agents, intended for, but in no way limited to, (1) application of the subject matter compositions to humans and animals exposed to toxic chemicals and/or biological agents, and/or (2) introduction of subject matter compositions to areas contaminated with toxic chemicals and/or biological agents. The kit is useful for utilizing the inventive compositions in treating such conditions. The kit is an assemblage of materials or components, including at least one of the inventive compositions. Thus, in some embodiments the kit contains a component including a chemical agent decontamination composition or a biological agent decontamination composition, or a combination thereof, as described above.

The exact nature of the components configured in the inventive kit depends on its intended purpose. For example, some embodiments are configured for the purpose of neutralizing a single individual exposed to a biological agent. The kit may also be configured for the purpose of applying the composition to large areas exposed to biological or chemical agents, such as a train station, bus, or city. In further embodiments, the kit may be configured for neutralization and decontamination of biological or chemical agents, for use in medical institutions.

Instructions for use may be included in the kit. “Instructions for use” typically include a tangible expression describing the technique to be employed in using the components of the kit to effect a desired outcome, such as neutralization and decontamination of biological or chemical agents found upon the skin and clothing of exposed humans. Optionally, the kit also contains other useful components such as water, a mixing container, a dispensing mechanism, an applicator, a mixing apparatus or other useful paraphernalia as will be readily recognized by those of skill in the art.

The materials or components assembled in the kit can be provided to the practitioner stored in any convenient and suitable ways that preserve their operability, sterility and/or utility. The components are typically contained in suitable packaging material(s). As employed herein, the phrase “packaging material” refers to one or more physical structures used to house the contents of the kit, such as inventive components and the like. The packaging material is constructed by well known methods, preferably to provide a sterile, contaminant-free environment. The packaging materials employed in the kit are those customarily utilized for compositions. As used herein, the term “package” refers to a suitable solid matrix or material such as glass, plastic, paper, foil, and the like, capable of holding the individual kit components. Thus, for example, a package can be plastic vials used to contain components of the inventive subject matter. The packaging material generally has an external label which indicates the contents and/or purpose of the kit and/or its components.

This decontamination and neutralization technology is attractive for civilian and military applications for several reasons including: 1) a single neutralization solution can be used for both CWA and BWA; 2) it can be rapidly deployed; 3) mitigation of CW agents and BW agents can be accomplished in bulk, aerosol, and vapor phases; 4) it exhibits minimal health and collateral damage to facilities, equipment, and the environment; 5) it requires minimal logistical support; 6) it has minimal run-off of fluids and no lasting environmental impact; and 7) it is relatively inexpensive.

Contemplated compositions can be delivered to the affected area in a variety of ways to provide the necessary decontamination. A useful form of delivery is foam. Non-toxic, non-corrosive neutral aqueous foams with enhanced physical stability for the rapid neutralization of CWA and BWA, have been developed. The foam formulation is based on a surfactant system which will solubilize sparingly soluble CWA and BWA and increase the rates of reaction with nucleophilic reagents. Contemplated compositions also may include additives including fatty alcohols and water-soluble polymers to enhance the physical stability of the foam.

A useful method for application of foams is based on aspiration or Venturi effect, whereby air is drawn into the foam-generating nozzle from the contaminated environment, which eliminates the need to pump additional air into a closed environment. This causes CWA and BWA contaminants in the air to be blended directly with the foam ingredients as the foams are made. In this way, the effectiveness of neutralization is enhanced significantly. Foams generated by this method have been shown to have a maximum expansion ratio of about 60-100:1 and have been shown to be stable for approximately 1-4 hours depending on environmental conditions (temperature, wind, relative humidity). Foams can also be generated by compressed air systems where air is directly injected into the liquid. Foam generated by this method generally has expansion ratios of about 20-60:1 and is stable from 1-4 hours.

Another useful method of application may include application by cream or hand sanitization of the affected area.

### EXAMPLES

Studies have been performed with contemplated compositions to determine the effectiveness of neutralization of CW and BW agents. All initial work was conducted with chemical agent simulants. For the G-agents the simulant, dimethyl methylphosphonate (“DMMP”) (CAS 756-79-6) was used. For VX, the simulant O,S-diethyl ethylthiophosphonate (“DEETP”) was used. For mustard, the simulant was 2-chloroethyl ethyl sulfide (“CEES”) (CAS 693-07-2). For the initial work on biological agents, simulants were used. The three biological simulants utilized were: Bacillus thuringiensis var. kurstaki (“Btk”) a spore forming bacteria, Escherichia coli (“E. Coli”) a vegetative bacteria, and bacteriophage MS2 (“MS2”) (ATCC 15597-B2) as a simulant for virus.

Testing on the chemical and biological agent simulants was performed at the Southwest Research Institute in San Antonio, Tex. The CWA simulant testing was performed on Chemical Agent Resistant Coating (“CARC”) coated aluminum plates to determine the effectiveness of the decon solutions. This CARC painted surface, is relatively porous, as opposed to a non-porous metallic surface, was used as a worse case scenario for the decon solutions. A porous surface tends to draw in the CWA or BWA making it more difficult for the decon solution to come in contact with the agent, react, and neutralize it. The general protocol for surface testing is described below:

Test procedures for CWA simulants included:
1. Inoculate test coupon with a known mass of chemical agent simulant.
2. Wait 60 minutes.
3. Apply decon formulation to the test coupon.
4. Wait specified time period (see examples).
5. Wash the surface of the coupon with solvent.
6. Extract the remaining CWA simulant from the coupon overnight with solvent.
7. Test wash and extraction solutions by gas chromatography (or GC-MS) to determine the amount of unreacted CWA simulant.
8. All CWA simulant testing was conducted at indicated pH of decon solution. All agents were CASARM-grade.

Testing for BWA simulants was conducted in the following manner. The microorganisms at a concentration of 10⁶ to 10⁸ microorganisms per mL were dispensed directly into a liquid phosphate buffered saline (“PBS”) solution. A measured amount of decon formulation is added to the PBS solution containing microorganisms. The solution is held at room temperature for 1 hour with stirring. At the end of the exposure period, the microorganisms are separated by either filtration or centrifugation, washed and re-suspended in fresh PBS buffer. Serial dilutions were performed, samples were plated, and the plates were incubated at the appropriate temperature for the appropriate amount of time. Concentrations of viable microorganisms were determined by counting colonies on the sample plates. Controls for the tests were performed by carrying through an identical set of microorganisms, but treated with PBS instead of decon solution.

All tests were conducted at ambient room temperature (23° C.). The test coupons were made using CARC (MIL-C-53039A, Polyurethane Topcoat with Primer MIL-P-53022B epoxy on clean aluminum stock).

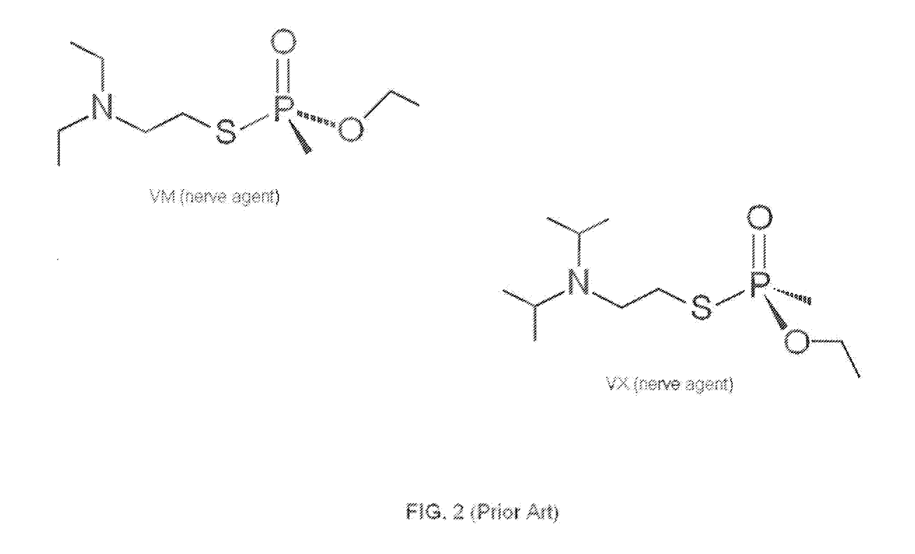

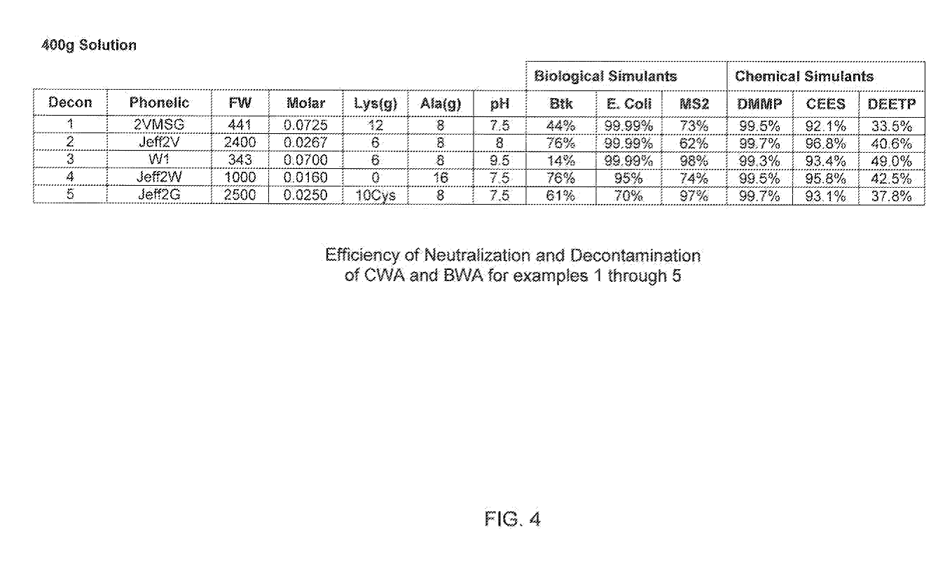

All tests were conducted under aseptic conditions to minimize potential of contamination by indigenous microorganisms. Controls were run to confirm the presence of aseptic conditions during the experiments. All tests were performed in triplicate and the results are reported as the average value from the three tests. FIG. 4 and FIG. 2 show results of the tests performed.

### Example 1

Decon Solution 1 was freshly prepared before use from 16 grams of 2VMSG, 12 grams Lysine, 8 grams Alanine, and 5.6 grams of NaHCO₃ in 400 mL of deionized water. This solution was used as described to neutralize CWA simulants and BWA simulants. The total destruction and removal efficiency (“DRE”) for this decon solution is Btk=44%, E. Coli=99.9999%, MS-2=73%, DMMP=99.5%, CEES=92.1%, DEETP=33.5%.

### Example 2

Decon Solution 2 was freshly prepared before use from 32 grams of Jeff2V, 6 grams Lysine, 8 grams Alanine, and 2.8 grams of NaHCO₃ in 400 mL of deionized water. This solution was used as described to neutralize CWA simulants and BWA simulants. The total DRE for this decon solution is Btk=76%, E. Coli=99.99999%, MS-2=62%, DMMP=99.7%, CEES=96.8%, DEETP=40.6%.

### Example 3

Decon Solution 3 was freshly prepared before use from 12 grams of W1, 6 grams Lysine, 8 grams Alanine, and 3 grams of NaOH in 400 mL of deionized water. This solution was used as described to neutralize CWA simulants and BWA simulants. The total DRE for this decon solution is Btk=14%, E. Coli=99.9999%, MS-2=98%, DMMP=99.3%, CEES=93.4%, DEETP=49%.

### Example 4

Decon Solution 4 was freshly prepared before use from 8 grams of Jeff2W, 16 grams Alanine, and 2.8 grams of NaHCO₃ in 400 mL of deionized water. This solution was used as described to neutralize CWA simulants and BWA simulants. The total DRE for this decon solution is Btk=76%, E. Coli=95%, MS-2=74%, DMMP=99.5%, CEES=95.8%, DEETP=42.5%.

### Example 5

Decon Solution 5 was freshly prepared before use from 32 grams of Jeff2G, 8 grams Alanine, 10 grams cysteine, and 2.8 grams of NaHCO₃ in 400 mL of deionized water. This solution was used as described to neutralize CWA simulants and BWA simulants. The total DRE for this decon solution is Btk=61%, E. Coli=70%, MS-2=97%, DMMP=99.7%, CEES=93.1%, DEETP=37.8%.

### Example 6

Decon Solution AA was freshly prepared before use from 8 grams of 2VMSG, 4 grams Alanine, 2 grams SLS, and 1 gram of NaHCO₃ in 200 mL of deionized water forming a solution of pH=7.5. This solution was used as described to neutralize BWA simulant—Btk. The total DRE for this decon solution is Btk=98%.

### Example 7

Decon Solution BB was freshly prepared before use from 8 grams of Jeff2V, 2 grams SLS, and 1 gram of Triton X114 in 200 mL of deionized water forming a solution of pH=7.0. This solution was used as described to neutralize BWA simulant—Btk. The total DRE for this decon solution is Btk=86%.

### Example 8

Decon Solution CC was freshly prepared before use from 4 grams of Jeff2V, 2 grams of 2V1Ala, 2 grams SLS, and 1 gram of Triton X114 in 200 mL of deionized water forming a solution of pH=7.0. This solution was used as described to neutralize BWA simulant—Btk. The total DRE for this decon solution is Btk=92%.

### Example 9

Decon Solution DD was freshly prepared before use from 8 grams of Jeff2W, 4 grams Alanine, 2 grams SLS, and 0.6 gram of NaHCO₃ in 200 mL of deionized water forming a solution of pH=7.5. This solution was used as described to neutralize BWA simulant—Btk. The total DRE for this decon solution is Btk=97%.

### Example 10

Decon Solution EE was freshly prepared before use from 8 grams of Jeff2W, 2 grams SLS, 1 gram of Triton X114, and 0.5 gram of NaHCO₃ in 200 mL of deionized water forming a solution of pH=7.5. This solution was used as described to neutralize BWA simulant—Btk. The total DRE for this decon solution is Btk=66%.

### Example 11

Decon Solution FF was freshly prepared before use from 8 grams of 2VSer, 1.5 grams of Triton X114, 1.5 grams of Triton X45, and 0.75 gram of NaHCO₃ in 200 mL of deionized water forming a solution of pH=7.5. This solution was used as described to neutralize BWA simulant—Btk. The total DRE for this decon solution is Btk=58%.

Thus, specific embodiments and applications of compositions for neutralization and decontamination of toxic chemical and biological agents have been disclosed. The foregoing description of various embodiments of the subject matter known to the applicant at the time of filing this application is intended for the purposes of illustration and description. The present description is not intended to be exhaustive nor limit the subject matter to the precise form disclosed and many modifications and variations are possible in light of the above teachings. The embodiments described serve to explain the principles of the subject matter and its practical application and to enable others skilled in the art to utilize the subject matter in various embodiments and with various modifications as are suited to the particular use contemplated. Therefore, it is intended that the subject matter disclosed herein not be limited to the particular embodiments disclosed.

While particular embodiments of the present subject matter have been shown and described, it should be apparent, however, to those skilled in the art that many more modifications besides those already described are possible without departing from the inventive concepts herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A chemical agent and biological agent decontamination composition comprising effective amounts of:
a neutral aqueous solvent;
at least one surface active agent;
at least one reactive agent for accelerating hydrolysis; and
at least one free phenolic reactive agent containing a free phenolic moiety as a portion of a molecule.

2. The composition of claim 1 wherein the at least one surface active agent is an ionic surfactant.

3. The composition of claim 2 wherein the ionic surfactant is selected from the group consisting of anionic surfactants, cationic surfactants and zwitterionic surfactants.

4. The composition of claim 1 wherein the at least one reactive agent is selected from the group consisting of amino acids, betaines, B-vitamins, weak acids and buffered salts.

5. The composition of claim 1 further comprising an amino acid.

6. The composition of claim 1 further comprising a neutral zwitterionic structure.

7. The composition of claim 1 further comprising a polar water soluble vitamin.

8. The composition of claim 1, wherein the free phenolic reactive agent is selected from the group consisting of eugenol, tannins, capsaicin, vanillin, salicylic acids, gallic acids, ellagic acids, ethyl vanillin (3-ethoxy-4-hydroxybenzaldehyde), carvacrol, curcumin, oleocanthal, oleuropein, piceatannol, pterostilbene. resveratrol, salicylaldehyde, tyrosol, hydroxytyrosol, vanillic acid and alkyl vanillate.

9. The composition of claim 1, wherein the free phenolic reactive agent is a polyphenol.

10. The composition of claim 1 further comprising a water soluble polymer for modifying the viscosity of the aqueous solvent.

11. The composition of claim 1 further comprising a foam forming material.

12. A chemical agent and biological agent decontamination composition comprising effective amounts of:
a neutral aqueous solvent;
at least one surface active agent;
at least one reactive agent for participating in nucleophilic reactions in water; and
at least one free phenolic reactive agent containing a free phenolic moiety as a portion of a molecule.

13. The composition of claim 12 wherein the at least one surface active agent is an ionic surfactant.

14. The composition of claim 13 wherein the ionic surfactant is selected from the group consisting of anionic surfactants, cationic surfactants and zwitterionic surfactants.

15. The composition of claim 12 wherein the at least one reactive agent is selected from the group consisting of amino acids, betaines, B-vitamins, weak acids and buffered salts.

16. The composition of claim 12 further comprising an amino acid.

17. The composition of claim 12 further comprising a neutral zwitterionic structure.

18. The composition of claim 12 further comprising a polar water soluble vitamin.

19. The composition of claim 12, wherein the free phenolic reactive agent is selected from the group consisting of eugenol, tannins, capsaicin, vanillin, salicylic acids, gallic acids, ellagic acids, ethyl vanillin (3-ethoxy-4-hydroxybenzaldehyde), carvacrol, curcumin, oleocanthal, oleuropein, piceatannol, pterostilbene. resveratrol, salicylaldehyde, tyrosol, hydroxytyrosol, vanillic acid and alkyl vanillate.

20. The composition of claim 12, wherein the free phenolic reactive agent is a polyphenol.

21. The composition of claim 12 further comprising a water soluble polymer for modifying the viscosity of the aqueous solvent.

22. The composition of claim 12 further comprising a foam forming material.

23. A kit for decontamination of biological agents comprising:
at least one surface active agent;
at least one reactive agent for accelerating hydrolysis; and
at least one free phenolic reactive agent containing a free phenolic moiety as a portion of a molecule.

24. A kit for decontamination of chemical agents comprising:
at least one surface active agent;
at least one reactive agent for participating in nucleophilic reactions in water; and
at least one free phenolic reactive agent containing a free phenolic moiety as a portion of a molecule.

25. A kit for decontamination of biological agents and chemical agents comprising:
at least one surface active agent;
at least one reactive agent for accelerating hydrolysis;
at least one reactive agent for participating in nucleophilic reactions in water; and
at least one free phenolic reactive agent containing a free phenolic moiety as a portion of a molecule.

26. A method for decontamination of chemical agents or biological agents comprising:
providing a composition comprising:
a neutral aqueous solvent;
at least one surface active agent;
at least one reactive agent for accelerating hydrolysis; and
at least one free phenolic reactive agent containing a free phenolic moiety as a portion of a molecule, and
applying the composition to a contaminated area.

27. A method for decontamination of chemical agents or biological agents comprising:
providing a composition comprising:
a neutral aqueous solvent;
at least one surface active agent;
at least one reactive agent for participating in nucleophilic reactions on water; and
at least one free phenolic reactive agent containing a free phenolic moiety as a portion of a molecule, and
applying the composition to a contaminated area.
